(19) United States
(12) Patent Application Publication
(10) Pub. No.: US 2012/0308880 A1
(43) Pub. Date: Dec. 6, 2012

(54) POROUS LI4TI5O12 ANODE MATERIAL, METHOD OF MANUFACTURING THE SAME AND BATTERY COMPRISING THE SAME

(75) Inventors: Jenq Gong DUH, Hsinchu (TW); Chih Yuan LIN, Hsinchu (TW)

(73) Assignee: NATIONAL TSING HUA UNIVERSITY, Hsinchu (TW)

(21) Appl. No.: 13/337,981

(22) Filed: Dec. 27, 2011

(30) Foreign Application Priority Data
Jun. 2, 2011 (TW) 100119369

(51) Int. Cl. H01M 4/131; H01M 10/056

(52) U.S. Cl. 429/188; 252/182.1

(57) ABSTRACT

The present invention relates to a porous lithium titanium oxide anode material, a method of manufacturing the same, and a battery comprising the same. The method of manufacturing a porous lithium titanium oxide anode material of the present invention includes the following steps: (A) mixing a lithium salt and an organic acid, and adding a titanium salt immediately; (B) performing a first heat treatment at 300-800° C. for three hours; and (C) performing a second heat treatment at 600-800° C. for ten hours to obtain a porous lithium titanium oxide anode material. The cost of manufacturing the porous lithium titanium oxide anode material can be reduced through the aforementioned method, and a lithium battery having excellent electrochemical properties and cycling stabilities can be produced by the present invention.

### BACKGROUND OF THE INVENTION

1. Field of the Invention

The present invention relates to a porous lithium titanium oxide anode material, a method of manufacturing the same, and a battery comprising the same. Particularly, the modified conventional solid state method of synthesizing a porous lithium titanium oxide anode material is shown.

2. Description of Related Art

Compared with lead acid batteries and nickel hydride batteries, lithium batteries have high working voltage, high energy density, long cycling life, and light weight. Therefore, lithium batteries have been used in mobile devices and as power sources for electric vehicles.

At present, lithium batteries predominantly use a carbon material as an anode material. However, the carbon material as the anode material is easily reacted with an electrolyte to form solid electrolyte interlayer (SEI), which causes a safety problem of the battery. Furthermore, because the carbon material has 2-D lithium-ion diffusion pathway, lithium batteries of this type are unable to perform the charge/discharge cycles rapidly. Therefore, developing a secure lithium titanium oxide anode material for lithium batteries, which can perform the charge/discharge cycles rapidly, is required. Lithium batteries which perform the charge/discharge cycles rapidly, and have superior safety and long cycling life, are formed by using improved high performance and low cost electrode materials, an electrolyte with high ignition point, and superior heat-resistance isolation membranes.

In anode materials, a high performance lithium titanium oxide has been used as the anode material of lithium batteries. The structure of the lithium titanium oxide is not changed in the charge/discharge process so as to provide a superior cycling stability. A spinel structure of the lithium titanium oxide is used as 3-D lithium-ion pathway, so that lithium ions can insert/de-insert rapidly. When the said material has porous structure, it may substantially improve electrochemical properties and cycling stabilities of lithium batteries.

Currently, the porous lithium titanium oxide is formed by using an expensive spray granulation machine, so that the cost of manufacturing the anode material of lithium batteries increases, making the resultant product uneconomical and not well suited for mass production. Therefore, the present invention provides an economic and easy synthesizing method, and reduces the cost of manufacturing the porous lithium titanium oxide to increase the market value of the resultant manufactured lithium batteries.

### SUMMARY OF THE INVENTION

The object of the present invention is to provide a method of manufacturing a porous lithium titanium oxide anode material, which is formed by using an economic and easy synthesizing method without requiring an expensive machine. It reduces the cost of manufacturing the porous lithium titanium oxide anode material, and provides the method of manufacturing the porous lithium titanium oxide anode material for mass production so as to increase the market value of the resultant manufactured lithium batteries.

It is another object of the present invention to provide a porous lithium titanium oxide anode material, which increases the contact area with the electrolyte, and reduces the diffusion pathway between electrons and ions to increase the charge/discharge rate and electrochemical properties. Therefore, the battery comprising the porous lithium titanium oxide anode material of the present invention has excellent cycling stabilities and safety.

In order to achieve the above object, the present invention provides a method of manufacturing a porous lithium titanium oxide anode material, which comprises the steps of: (A) mixing a lithium salt and an organic acid to form a starting solution; (B) mixing a titanium salt and the starting solution to form a mixed solution; (C) performing a first heat treatment at 300-800° C.; and (D) performing a second heat treatment at 600-800° C., to obtain a porous lithium titanium oxide anode material.

Furthermore, the present invention provides a porous lithium titanium oxide anode material, which comprises a plurality of material layers, wherein each of the material layers includes a plurality of lithium titanium oxide particles, and the material layers are arranged adjacently so that the lithium titanium oxide particles are arranged adjacently to form a plurality of holes, wherein the diameter of the hole is 1-10 μm. The lithium titanium oxide particles are Li₄Ti₅O₁₂.

In addition, the present invention further provides a lithium battery comprising a porous lithium titanium oxide anode material, which comprises a cathode, an anode which is made of the porous lithium titanium oxide anode material, and a lithium electrolyte which contacts with the cathode and the anode. The porous lithium titanium oxide anode material comprises a plurality of material layers, wherein each of the material layers includes a plurality of lithium titanium oxide particles, and the material layers are arranged adjacently so that the lithium titanium oxide particles are arranged adjacently to form a plurality of holes, wherein the diameter of the hole is 1-10 μm.

The present invention provides a method of manufacturing a porous lithium titanium oxide anode material. In step (A), the lithium salt may be selected from any reagent which can provide lithium-ions in the reaction, such as lithium chloride, lithium acetate, lithium carbonate, or lithium hydroxide, and preferably lithium chloride, but not particularly limited therein. The organic acid may be selected from oxalic acid, acetic acid, carbonic acid or nitric acid, and preferably oxalic acid, but not particularly limited thereto, wherein oxalic acid may be in the concentration of 20 to 70 wt %, and preferably the concentration of 60 to 70 wt %. The reaction in step (A) is performed at a temperature in the range from 80 to 300° C., and preferably from 100 to 250° C. When the reagents are oxalic acid and lithium chloride, lithium oxalate and hydrogen chloride (HCl) gas are generated. The repulsive force in the molecules is generated due to HCl, and makes the molecules disperse reciprocally so as to suppress the formation of aggregates.

In step (B), the titanium salt may be selected from any reagent which provides titanium-ions in the reaction, such as titanium tetrachloride (TiCl₄), titanium dioxide (TiO₂), titanium trichloride (TiCl₃), or titanium isopropoxide (TTIP), and preferably titanium tetrachloride, but not particularly limited thereto. The reaction in this step is performed at a temperature in the range from 80 to 300° C., and preferably from 100 to 250° C.

In step (C), the first heat treatment may be at 300-800° C., and preferably at 400-600° C. The time of the first heat treatment may be 1-15 hours, and preferably 3-10 hours. In this step, Li₂TiO₃ compound is generated by reacting lithium-ions with anatase TiO₂, so that the synthesis yield of the porous lithium titanium oxide anode material is increased.

In step (D), the second heat treatment may be at 600-800° C., and preferably at 700-800° C. The time of the first heat treatment may be 3-20 hours, and preferably 10-15 hours. The first heat treatment of the step (C) can facilitate the diffusion of the lithium-ions into the anatase TiO₂ and the reaction thereof with the anatase TiO₂, and then the high-purity lithium titanium oxide can be obtained after the step (D) is completed.

Herein, if the step (C) is eliminated, namely the method of manufacturing the porous lithium titanium oxide anode material does not comprise the step (C) after mixing salts and organic acid in the steps (A) and (B), but performs violent calcination of the step (D) directly, the lithium titanium oxide powder would comprise rutile impurities so as to reduce electrochemical properties. In the steps (C) and (D), the gas is released after heating organic acid, so that the repulsive force is generated in the material. After the material performs the heat treatment and releases the gas, the lithium titanium oxide anode material having porous structure is obtained.

Therefore, the present invention provides a method of manufacturing a porous lithium titanium oxide anode material, which modifies a conventional solid-state synthesizing method. In this method, after the reagents in the reactions of the method are mixed thoroughly, a two stage heat treatment is further performed on the mixed solution, so the process of the present invention is easy and convenient. In addition, it is unnecessary to use an expensive machine or to perform complicated synthesizing steps to obtain the porous lithium titanium oxide anode material in the present invention.

Herewith, the diameter of the hole in the porous lithium titanium oxide anode material of the present invention may be 1-10 μm, and preferably 1-3 μm. Each of the holes in the porous lithium titanium oxide anode material is formed by 10-100 lithium titanium oxide particles arranged adjacently, and preferably 15-50 lithium titanium oxide particles. The porous structure is formed by randomly distributed holes having non-uniform size, and it looks like a formicary-like non-uniform porous structure.

Furthermore, the porous lithium titanium oxide anode material of the present invention may be used to manufacture a lithium battery, wherein a cathode material may be lithium iron phosphate (LiFePO₄), and an anode material may be the porous lithium titanium oxide anode material of the present invention. The lithium battery formed by using the said materials has excellent safety and electrochemical properties, and overcomes some problems such as the explosion of the battery.

Since the structure of the porous lithium titanium oxide anode material of the present invention soaks in the electrolyte, the contact area between the anode material and the electrolyte is increased. Furthermore, the porous lithium titanium oxide anode material reduces the diffusion pathway between electrons and ions, and improves the conductivity and electrochemical properties of the Li₄Ti₅O₁₂ material, and also increases the charge/discharge rate (C-rate) of the battery. Herein, the charge/discharge rate of the battery comprising the porous lithium titanium oxide anode material of the present invention may be from 0.5 C to 10 C, preferably from 0.5 C to 5 C, and more preferably from 0.5 C to 1 C. When the charge/discharge rate is 0.5 C (87.5 mA), the capacity is from 167 to 170 mAh/g, which is very close to the theoretical capacity of the porous Li₄Ti₅O₁₂ anode material (175 mAh/g). When the charge and discharge rate is 1 C (175 mA), the capacity is from 135 to 150 mAh/g. When the charge and discharge rate is 10 C, the capacity will be 70 mAh/g.

Therefore, the present invention provides a porous lithium titanium oxide anode material, a method of manufacturing the same, and a battery comprising the same. The advantages are as follows. (1) The porous lithium titanium oxide anode material is formed by using the modified conventional solid state synthesizing method. This synthesizing method is easy, economic, and does not require an expensive machine. Hence, the cost of manufacturing the porous lithium titanium oxide anode material can be reduced, and the material can be mass-produced and be used for commercial applications. (2) This anode material is a porous lithium titanium oxide anode material, which increases the contact area between the anode material and the electrolyte, and reduces the diffusion pathway between electrons and ions. Moreover, the lithium titanium oxide anode material improves the electrochemical properties and the charge/discharge rate of the battery. (3) The capacity of the battery is very close to the theoretical capacity (about 98%), and therefore the usability of lithium batteries can be increased. (4) The battery comprising the porous lithium titanium oxide anode material, which has excellent cycling stabilities and safety. After performing the charge/discharge process over 200 times, the initial capacity of the battery can still be maintained, which shows that the porous lithium titanium oxide anode material presents excellent cycling stabilities and safety.

### BRIEF DESCRIPTION OF THE DRAWINGS

FIG. 1 is a SEM image of a porous lithium titanium oxide anode material according to Example 1 of the present invention;

FIG. 2 is a SEM image of a non-porous lithium titanium oxide synthesized by a conventional solid-state method (Comparative Example 1);

FIG. 3A is a figure, which shows XRD patterns of (a) the porous lithium titanium oxide anode material according to Example 1 of the present invention and (b) the non-porous lithium titanium oxide according to Comparative Example 1;

FIG. 3B is an XRD pattern of porous lithium titanium oxide anode materials according to Example 1 of the present invention at different heat treatments;

FIG. 4 is an impedance spectrum of lithium titanium oxide according to Example 1 of the present invention and Comparative Example 1 respectively;

FIG. 5 is a potential-capacity diagram of porous lithium titanium oxide anode materials according to Example 1 of the present invention at different charge/discharge cycle numbers;

FIG. 6 is a figure, which shows capacity-charge/discharge cycle numbers diagrams of Example 1 of the present invention and Comparative Example 1 respectively;

FIG. 7 is a capacity-charge/discharge cycle numbers diagram of Example 1 of the present invention at different discharge rate; and

FIG. 8 is a capacity-charge/discharge cycle numbers diagram of Example 1 of the present invention at different charge/discharge rate.

### DETAILED DESCRIPTION OF THE PREFERRED EMBODIMENT

Herein below, the present invention will be described in detail with reference to the embodiments. The present invention may, however, be embodied in many different forms and should not be construed as being limited to the embodiments set forth herein. Rather, these embodiments are provided to fully convey the concept of the invention to those skilled in the art.

### EXAMPLE 1

The present invention provides a method of manufacturing a porous lithium titanium oxide anode material, which modifies a conventional solid state method of synthesizing the porous lithium titanium oxide anode material so as to substantially reduce the cost of manufacturing the porous lithium titanium oxide anode material. The method of manufacturing the porous lithium titanium oxide anode material includes the following steps:

First, a mixed solution is prepared by mixing lithium chloride and 70 wt % of oxalic acid thoroughly, dropping titanium tetrachloride into the mixture immediately to avoid the hydrolysis of titanium tetrachloride in air, and heating said solution at 100-250° C. for a half hour. At this time, a repulsive force is slightly formed by releasing HCl gas so as to suppress the formation of aggregates.

Then, a first heat treatment is performed on the mixed solution at 400-600° C. and sintered for 3 hours. In this step, the reaction of lithium-ions with anatase TiO₂ is mixed uniformly through this gentle heat treatment, so that the synthesis yield of the porous lithium titanium oxide anode material is increased.

Finally, a second heat treatment at 800° C. and sintering for 10 hours is further performed on the production formed by the above steps. After oxalate anion in the solution is heated, carbon dioxide gas is released. The repulsive force in the molecules is generated due to the carbon dioxide gas, and irregular holes in the material are formed by the release of the carbon dioxide gas, so that a non-uniform porous lithium titanium oxide anode material is obtained. In this step, residual impurities such as titanium dioxide which are not reacted with Li₂O, and impurities can be removed through this high temperature heat treatment.

Accordingly, the said method of manufacturing a porous lithium titanium oxide anode material comprises a plurality of material layers, wherein each of the material layers includes a plurality of lithium titanium oxide particles, and the material layers are arranged adjacently so that the lithium titanium oxide particles are arranged adjacently to form a plurality of holes, wherein the diameter of the hole is 1-10 μm, and each of the holes is formed by 15-50 lithium titanium oxide particles which are adjacently arranged. The lithium titanium oxide particle is in a diameter of 200-500 nm. The lithium titanium oxide particles are Li₄Ti₅O₁₂.

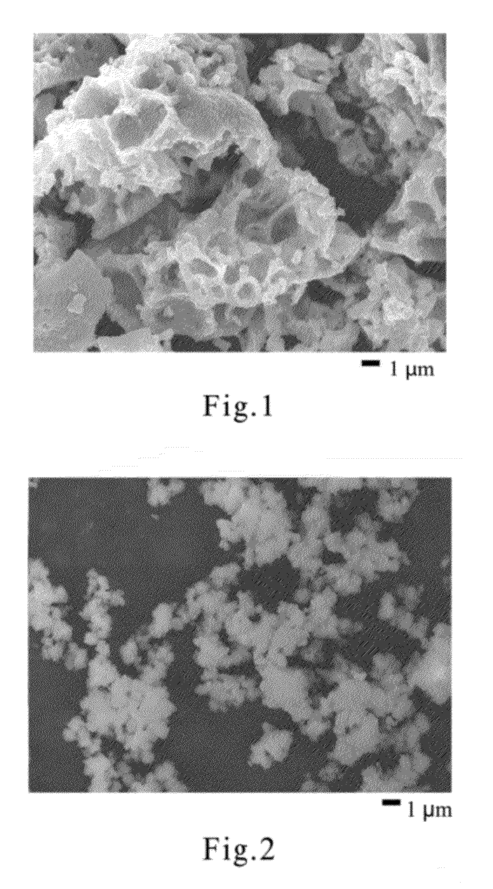

The feature and the size of the particle of a porous lithium titanium oxide anode material can be observed by field emission-scanning electronic microscopy (FE-SEM). Referring to FIG. 1, a SEM image of the porous lithium titanium oxide anode material according to Example 1 of the present invention is shown. As shown in FIG. 1, the lithium titanium oxide material may have porous structure having non-uniform holes, and it looks like a formicary-like non-uniform porous structure.

Furthermore, a lithium battery having high performance and low cost is prepared by using the porous lithium titanium oxide anode material of the present invention. The battery, comprising: a cathode, an anode which is made of the porous lithium titanium oxide anode material of the present invention, and a lithium electrolyte which contacts with the cathode and the anode, wherein the porous lithium titanium oxide anode material comprises a plurality of material layers, wherein each of the material layers includes a plurality of lithium titanium oxide particles, and the material layers are arranged adjacently so that the lithium titanium oxide particles are arranged adjacently to form a plurality of holes, wherein the diameter of the hole is 1-10 μm. The lithium titanium oxide particles are Li₄Ti₅O₁₂. Herein, the anode material is a material having porous structure. Thus, the material can increase the contact area with the electrolyte, and reduce the diffusion pathway between electrons and ions to increase the electrical property of the battery.

### COMPARATIVE EXAMPLE 1

In Comparative Example 1, a lithium titanium oxide synthesized by using a conventional solid state method, wherein the conventional solid state method, comprising the following steps:

First, anatase TiO₂ and LiCl in a molar ratio of 4:5 is mixed uniformly for 5 hours through a ball mill machine. Then, the powder is heated at 800° C. for 10 hours so as to obtain Li₄Ti₅O₁₂.

Here, the feature of the Li₄Ti₅O₁₂ material can be observed by FE-SEM. As shown in FIG. 2, the Li₄Ti₅O₁₂ synthesized by using the conventional solid state method has a non-porous structure, and Li₄Ti₅O₁₂ particles are easily aggregated so as to form the non-uniform aggregates.

### EXPERIMENTAL EXAMPLE 1

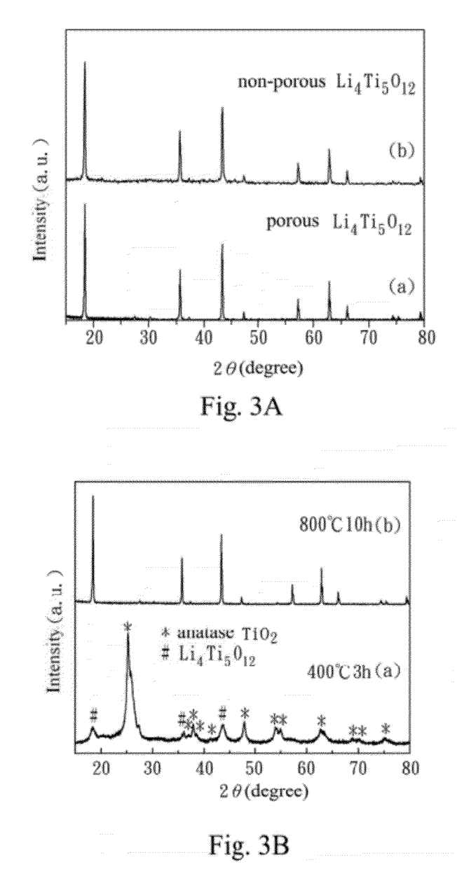

In Experimental Example 1, a crystal structure of the porous lithium titanium oxide anode material (from Example 1) is identified by the X-ray diffraction (XRD). The material obtained by performing different heat treatments in Example 1 can also be identified by the XRD. Referring FIG. 3A, XRD patterns of (a) the porous lithium titanium oxide anode material according to Example 1 of the present invention, and (b) the non-porous lithium titanium oxide according to Comparative Example 1 are shown. FIG. 3B is a XRD pattern of Example 1 of the present invention at different heat treatments.

As shown in FIG. 3A, the characteristic diffraction peaks of (a) Example 1 and (b) Comparative Example 1 are the same, and the lattice parameter is 0.8354 nm and 0.8372 nm by the Rietveld method for the porous lithium titanium oxide anode material and non-porous lithium titanium oxide respectively. The lattice parameters are almost the same in both examples, and it shows the lithium titanium oxide prepared by the said methods is Li₄Ti₅O₁₂ having spinel structure.

The XRD pattern of the porous lithium titanium oxide anode material of the present invention (Example 1) obtained by sintering at 400° C. for 3 hours, is shown in FIG. 3B(a). Wherein, the diffraction peaks of anatase TiO₂ are shown as 25.3, 36.9, 37.9, 38.6, 47.9, 54.2, 55.1, 62.8, 68.9, 70.2, and 75.2 degrees at 2θ. The diffraction peaks of Li₄Ti₅O₁₂ are shown as 18.4, 35.6, and 43.6 degrees at 2θ. It further shows anatase TiO₂ and Li₄Ti₅O₁₂ are both present after performing the first heat treatment.

The material is further sintered at 800° C. for 10 hours after performing the first heat treatment, and the XRD pattern of the final material is shown in FIG. 3B(b). In FIG. 3B(b), only the characteristic diffraction peaks of Li₄Ti₅O₁₂ are shown. Therefore, the high purity Li₄Ti₅O₁₂ is obtained by performing the second heat treatment.

### EXPERIMENTAL EXAMPLE 2

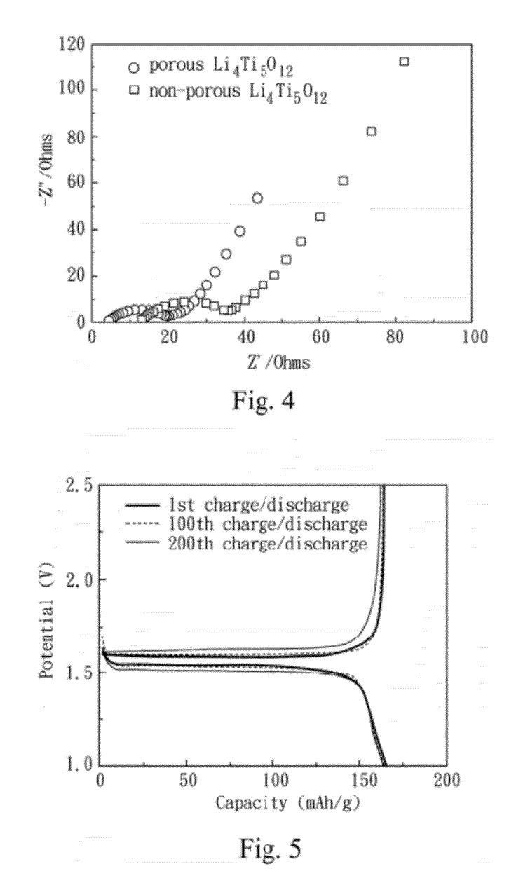

In Experimental Example 2, the electrochemical properties of a battery comprising the porous Li₄Ti₅O₁₂ anode material (Example 1) and the battery comprising Li₄Ti₅O₁₂ synthesized by the conventional solid state method (Comparative Example 1), are compared by Electrochemical AC impedance Spectrum (EIS). Furthermore, the cycling stability of the battery comprising the porous lithium titanium oxide anode material is tested through the charge/discharge experiment with constant current. Referring to FIG. 4, an impedance spectrum of Example 1 and Comparative Example 1 respectively, and FIG. 5 is a potential-capacity diagram of Example 1 at different charge/discharge cycle numbers.

As shown in FIG. 4, it shows the impedance spectrum of the batteries of Example 1 and Comparative Example 1, which are discharged to 1.5. The low frequency region of the straight line is attributed to the Warburg impedance of lithium ion diffusion. The diffusion coefficient of lithium ion (Li⁺) for Example 1 is 2.86×10⁻⁹ cm²/s, and the diffusion coefficient of lithium ion (Li⁺) for Comparative Example 1 is 1.10×10⁻¹⁰ cm²/s. In FIG. 4, the battery comprising the porous lithium titanium oxide anode material (Example 1) has the larger diffusion coefficient of lithium ion (Li⁺) and lower battery resistance, so that the battery has superior electrochemical properties, higher charge/discharge rate, and larger capacity.

As shown in FIG. 5, a potential-capacity diagram of the porous lithium titanium oxide anode material (Example 1) at 1st, 100th, and 200th charge/discharge cycle at 0.5 C charge/discharge rate is shown. After 200 charge/discharge cycles, the charge/discharge curve displays a flat plateau at the potential of about 1.5 V. The coulombic efficiency of the battery of the present invention is near 100%. Therefore, the porous lithium titanium oxide anode material of the present invention has excellent electrochemical reversibility, and increases the reusability of the battery.

### EXPERIMENT EXAMPLE 3

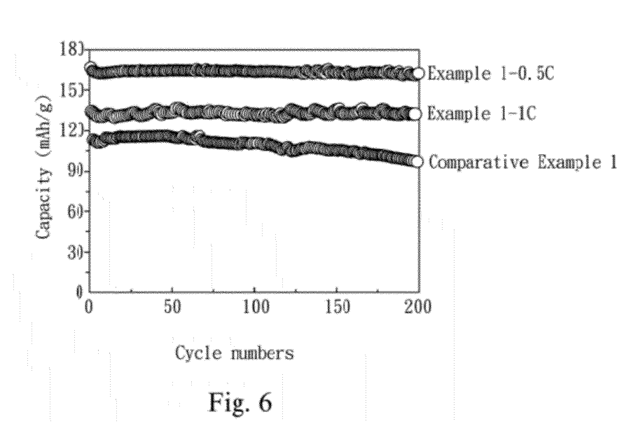

In Experiment Example 3, the cycling stability and the capacity of the lithium battery comprising the porous lithium titanium oxide anode material (Example 1), and the lithium battery comprising the non-porous lithium titanium oxide synthesized by the conventional solid state method (Comparative Example 1), are compared through different charge/discharge cycles. Referring to FIG. 6, capacity-charge/discharge cycle numbers diagrams of Example 1 and Comparative Example 1 are shown respectively.

As shown in FIG. 6, the capacity of the porous lithium titanium oxide anode material at a charge/discharge rate of 0.5 C exhibits 167 mAh/g, which is very close to the theoretical capacity 175 mAh/g. Furthermore, the capacity of the porous lithium titanium oxide anode material at a charge/discharge rate of 1 C exhibits 133 mAh/g. Wherein, the capacity retention is as high as 98% after 200 charge/discharge cycles, and the capacity loss per cycle is only 0.01 mAh/g over 200 cycles. However, the capacity of the non-porous lithium titanium oxide material (Comparative Example 1) is about 115 mAh/g after the 1st charge, and the capacity falls obviously as the charge/discharge cycle numbers increase, indicating that the cycling stability of the battery comprising the non-porous lithium titanium oxide is not as good.

### EXPERIMENTAL EXAMPLE 4

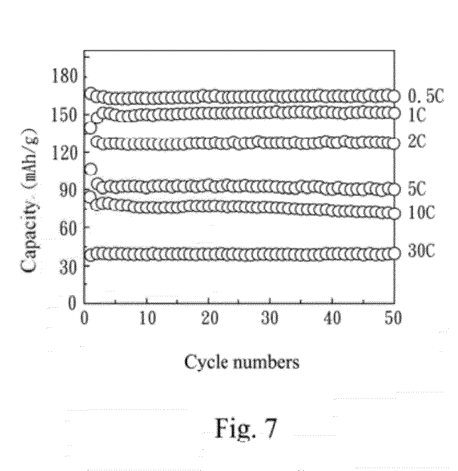

In Experimental Example 4, the charge/discharge cycling of the battery comprising the porous lithium titanium oxide anode material (Example 1) at 0.5 C charge rate is tested at different discharge rates. Referring to FIG. 7, a capacity-charge/discharge cycle numbers diagram of the battery comprising the porous lithium titanium oxide anode material (Example 1) at different discharge rates is shown.

After 200 charge/discharge cycles, the capacity of the battery at 0.5 C charge/discharge rate is 167 mAh/g, and the capacity of the battery charged at 0.5 C and discharged at 1 C is 150 mAh/g. When the battery is charged at 0.5 C and discharged at 1, 5, and 10 C, the capacity of the battery is shown 133, 100, and 80 mAh/g respectively. According to the results, when the battery comprising the porous lithium titanium oxide anode material of the present invention increases the discharge rate, it still maintains the capacity. Therefore, the applied value of the lithium batteries is substantially increased.

### EXPERIMENTAL EXAMPLE 5

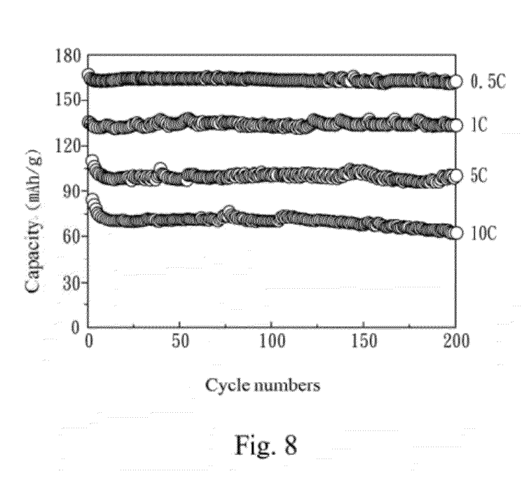

In Experimental Example 5, the charge/discharge cycling of the battery comprising the porous lithium titanium oxide anode material (Example 1) is tested at different charge/discharge rates. Referring to FIG. 8, a capacity-charge/discharge cycle numbers diagram of the battery comprising the porous lithium titanium oxide anode material (Example 1) at different charge/discharge rates is shown.

As shown in FIG. 8, the capacity is shown 167 mAh/g, 133 mAh/g, 100 mAh/g, and 70 mAh/g at 0.5 C, 1 C, 5 C, and 10 C charge/discharge rate respectively after 200 cycles. Therefore, the battery comprising the porous lithium titanium oxide anode material of the present invention has excellent charge/discharge cycling stability, and can enhance the capacity at different charge/discharge rates.

In conclusion, the porous lithium titanium oxide anode material of the present invention increases the contact area between the anode material and the electrolyte, and reduces the diffusion pathway of the lithium ion and the transport pathway of electron, so that the battery may have superior electrochemical properties and excellent cycling stability. Therefore, the convenience of using the battery is increased so as to enhance the market value in application.

Although the present invention has been explained in relation to its preferred embodiment, it is to be understood that many other possible modifications and variations can be made without departing from the scope of the invention as hereinafter claimed.

What is claimed is:

1. A method of manufacturing a porous lithium titanium oxide anode material, comprising the steps of:
(A) mixing a lithium salt and an organic acid to form a starting solution;
(B) mixing a titanium salt and the starting solution to form a mixed solution;
(C) performing a first heat treatment at 300-800° C.; and
(D) performing a second heat treatment at 600-800° C., to obtain a porous lithium titanium oxide anode material.

2. The method of manufacturing a porous lithium titanium oxide anode material according to claim 1, wherein the reaction temperature is 80-300° C. in step (A), and step (B), respectively.

3. The method of manufacturing a porous lithium titanium oxide anode material according to claim 1, wherein the lithium salt is lithium chloride, lithium acetate, lithium carbonate, or lithium hydroxide.

4. The method of manufacturing a porous lithium titanium oxide anode material according to claim 1, wherein the titanium salt is titanium tetrachloride, titanium dioxide, titanium isopropoxide (TTIP), or titanium trichloride.

5. The method of manufacturing a porous lithium titanium oxide anode material according to claim 1, wherein the organic acid is oxalic acid, acetic acid, carbonic acid, or nitric acid.

6. The method of manufacturing a porous lithium titanium oxide anode material according to claim 5, wherein the oxalic acid is in the concentration of 20-80 wt %.

7. The method of manufacturing a porous lithium titanium oxide anode material according to claim 1, wherein the time of performing the first heat treatment is 1-15 hours.

8. The method of manufacturing a porous lithium titanium oxide anode material according to claim 1, wherein the time of performing a second heat treatment is 3-20 hours.

9. A porous lithium titanium oxide anode material, comprising:
a plurality of material layers, wherein each of the material layers includes a plurality of lithium titanium oxide particles, and the material layers are arranged adjacently so that the lithium titanium oxide particles are arranged adjacently to form a plurality of holes,
wherein the diameter of the hole is 1-10 μm.

10. The porous lithium titanium oxide anode material according to claim 9, wherein the porous lithium titanium oxide anode material is formicary-like non-uniform porous material.

11. The porous lithium titanium oxide anode material according to claim 9, wherein each of the holes is formed by 15-50 lithium titanium oxide particles which are adjacently arranged.

12. The porous lithium titanium oxide anode material according to claim 9, wherein the porous lithium titanium oxide anode material is formed by using the following steps:
(A) mixing a lithium salt and an organic acid to form a starting solution;
(B) mixing a titanium salt and the starting solution to form a mixed solution;
(C) performing a first heat treatment at 300-800° C.; and
(D) performing a second heat treatment at 600-800° C., to obtain a porous lithium titanium oxide anode material.

13. The porous lithium titanium oxide anode material according to claim 9, wherein lithium titanium oxide particles are Li₄Ti₅O₁₂.

14. The porous lithium titanium oxide anode material according to claim 13, wherein the lithium titanium oxide particle is in a diameter of 200-500 nm.

15. A lithium battery comprising a porous lithium titanium oxide anode material, comprising:
a cathode;
an anode which is made of the porous lithium titanium oxide anode material; and
a lithium electrolyte which contacts with the cathode and the anode;
wherein the porous lithium titanium oxide anode material comprises a plurality of material layers, each of the material layers includes a plurality of lithium titanium oxide particles, the material layers are arranged adjacently so that the lithium titanium oxide particles are arranged adjacently to form a plurality of holes, and the diameter of the hole is 1-10 μm.

16. The lithium battery comprising a porous lithium titanium oxide anode material according to claim 15, wherein the porous lithium titanium oxide anode material is formed by using the following steps:
(A) mixing a lithium salt and an organic acid to form a starting solution;
(B) mixing a titanium salt and the starting solution to form a mixed solution;
(C) performing a first heat treatment at 300-800° C.; and
(D) performing a second heat treatment at 600-800° C., to obtain a porous lithium titanium oxide anode material.

17. The lithium battery comprising a porous lithium titanium oxide anode material according to claim 15, wherein the porous lithium titanium oxide anode material is formicary-like non-uniform porous material.

18. The lithium battery comprising a porous lithium titanium oxide anode material according to claim 15, wherein lithium titanium oxide particles are Li₄Ti₅O₁₂.

19. The lithium battery comprising a porous lithium titanium oxide anode material according to claim 18, wherein lithium titanium oxide particle is in a diameter of the 200-500 nm.
